(19) United States
(12) Patent Application Publication
(10) Pub. No.: US 2026/0211633 A1
(43) Pub. Date: Jul. 23, 2026

(54) METHOD, APPARATUS, DEVICE, AND MEDIUM FOR CHECKING INTERFACE OF APPLICATION

(71) Applicant: Beijing Zitiao Network Technology Co., Ltd., Beijing (CN)

(72) Inventor: Guandong Li, Beijing (CN)

(21) Appl. No.: 19/093,200

(22) Filed: Mar. 27, 2025

Related U.S. Application Data
(63) Continuation of application No. PCT/CN2025/073778, filed on Jan. 21, 2025.

(51) Int. Cl. G06F 8/34; G06F 3/0482; G06F 3/0484

(52) U.S. Cl. CPC G06F 8/34; G06F 3/0482; G06F 3/0484

(57) ABSTRACT

A method, an apparatus, a device, and a medium for checking an interface of an application are provided. In a method, at least one visual element in the interface of the application is determined based on an interface description of the interface of the application. A constraint associated with the interface of the application is obtained. The at least one visual element is checked based on the constraint. In response to determining that a visual element of the at least one visual element does not meet the constraint, alert information is provided to indicate that the visual element fails an interface check. According to an implementation of the disclosure, whether respective visual elements in the interface of the application meet the constraint may be automatically checked. In this way, the interface check may be performed in a more efficient manner, thereby improving the development efficiency of the application.

### CROSS REFERENCE

This application claims priority to PCT Application No. PCT/CN2025/073778, filed on Jan. 21, 2025, and entitled “METHOD, APPARATUS, DEVICE, AND MEDIUM FOR CHECKING INTERFACE OF APPLICATION”, the entirety of which is incorporated herein by reference.

### FIELD

Implementations of the disclosure generally relate to application management, and in particular, to a method, an apparatus, a device, and a computer-readable storage medium for checking an interface of an application.

### BACKGROUND

With the development of computer technologies and Internet technologies, an application may provide a wide variety of functions. An interface of the application may include a large number of visual elements (e.g., menu items, buttons, text, images, etc.) in order to implement these functions. In an application development process, in order to ensure that the application may provide an expected function, it is necessary to check whether various visual elements meet a predetermined constraint. However, manual check results in a large amount of manpower and time overhead, and results in inefficient development efficiency. At this time, it is expected that the application interface may be checked in an automated manner, thereby improving the development efficiency of the application.

### SUMMARY

In a first aspect of the disclosure, a method for checking an interface of an application is provided. In the method, at least one visual element in an interface of an application is determined based on an interface description of an application interface. A constraint associated with the interface of the application is obtained. The at least one visual element is checked based on the constraint. In response to determining that a visual element of the at least one visual element fails to meet the constraint, alert information is provided to indicate that the visual element fails an interface check.

In a second aspect of the disclosure, an apparatus for checking an interface of an application is provided. The apparatus includes a determining module configured to determine at least one visual element in an interface of an application based on an interface description of the interface of the application; an obtaining module configured to obtain a constraint associated with the interface of the application; a checking module configured to check the at least one visual element based on the constraint; and a providing module configured to provide, in response to determining that a visual element of the at least one visual element fails to meet the constraint, alert information to indicate that the visual element fails an interface check.

In a third aspect of the disclosure, an electronic device is provided. The electronic device includes: at least one processor; and at least one memory coupled to the at least one processor and storing instructions for execution by the at least one processor, the instructions, when executed by the at least one processor, causing the electronic device to perform the method according to the first aspect of the disclosure.

In a fourth aspect of the disclosure, there is provided a computer-readable storage medium having stored thereon a computer program which, when executed by a processor, causes the processor to implement the method according to the first aspect of the disclosure.

In a fifth aspect of the disclosure, there is provided a computer program product, including a computer program, wherein the computer program, when executed by a processor, implements the method according to the first aspect of the disclosure.

It should be understood that the content described in this disclosure is not intended to limit key features or major features of implementations of the disclosure, nor is it intended to limit the scope of the disclosure. Other features of the disclosure will become readily understood from the following description.

### BRIEF DESCRIPTION OF DRAWINGS

The above and other features, advantages, and aspects of the various implementations of the disclosure will become more apparent from the following detailed description taken in conjunction with the accompanying drawings. In the drawings, the same or similar reference numbers refer to the same or similar elements, wherein:

FIG. 1 shows a block diagram of an application environment according to an implementation of the disclosure;

FIG. 2 shows a block diagram of checking an interface of an application according to some implementations of the disclosure;

FIG. 3 shows a block diagram of a check interface of a check tool according to some implementations of the disclosure;

FIG. 4 shows a block diagram of a further check interface of the check tool according to some implementations of the disclosure;

FIG. 5 shows a block diagram of an interactive interface of a check tool according to some implementations of the disclosure;

FIG. 6 shows a block diagram of a process of performing an interface check using an interface check tool according to some implementations of the disclosure;

FIG. 7 shows a flowchart of a method for checking an interface of an application according to some implementations of the disclosure;

FIG. 8 shows a block diagram of an apparatus for checking an interface of an application according to some implementations of the disclosure; and

FIG. 9 shows a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limitation to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the term “include” and similar terms should be understood as open-ended inclusion, i.e., “including but not limited to”. The term “based on” should be understood as “based at least in part on”. The terms “an implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations, and the authorization therefor should be obtained from the user.

For example, in response to receiving an active request from a user, prompt information is sent to the user to explicitly prompt the user that the requested operation will need to acquire and use the personal information of the user. Therefore, the user can autonomously select whether to provide personal information to software or hardware such as an electronic device, an application, a server and a storage medium executing the operation of the technical solution of the disclosure according to the prompt information.

As an optional but non-limiting implementation, in response to receiving an active request of the user, a manner of sending prompt information to the user may be, for example, in a manner of a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and a process for obtaining a user authorization is merely illustrative, and does not constitute a limitation on implementations of the disclosure, and other manners of meeting related laws and regulations may also be applied to implementations of the disclosure.

The term “responsive to” as used herein means a state in which a respective event occurs or a condition is satisfied. It will be appreciated that the timing of execution of a subsequent action performed in response to the event or condition is not necessarily strongly correlated with the time at which the event occurs or the condition is established. For example, in some cases, subsequent actions may be performed immediately when an event occurs or a condition holds; while in other cases, subsequent actions may be performed after a period of time elapses after an event occurs or a condition is established.

### Example Environment

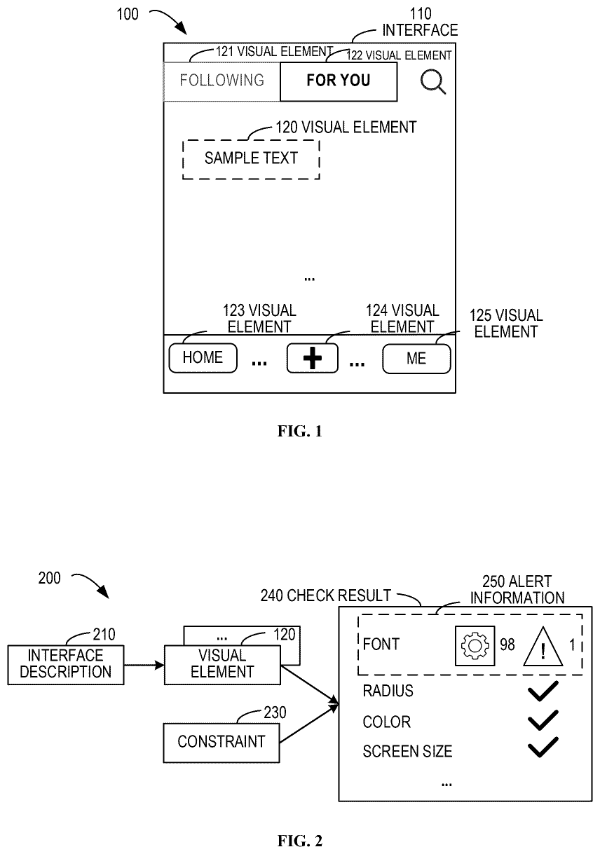

With the development of computer technologies and Internet technologies, an application may provide a wide variety of functions. An interface of the application may include a large number of visual elements (e.g., menu items, buttons, text, images, paging tabs, lists, selection boxes, etc.). FIG. 1 is a block diagram 100 of an application environment according to some implementations of the disclosure. As shown in FIG. 1, an interface 110 of the application may include a plurality of visual elements, and the visual element may include, for example, a control in the application. For example, visual elements 121 and 122 may represent paging tabs in the interface 110, visual elements 123, 124, and 125 may represent buttons in the application, the visual elements may include text in the application, and the like.

In an application development process, in order to ensure that an application may provide an expected function, it is necessary to check whether various visual elements meet a predetermined constraint. For example, it may be necessary to check whether various attributes (e.g., a shape, a size, a position, a corresponding text, etc.) of respective visual elements meet requirements. Manual check may result in a large amount of labor and time overhead, and result in inefficient development efficiency. Although a check tool has been currently provided to assist in the interface check, the flexibility of existing tools is poor, and developers cannot define constraints for the visual elements. Further, the developer needs to switch back and forth between the check tool and the interface of the application, which results in lower efficiency. At this time, it is expected that the application interface may be checked in an automated manner, thereby improving the development efficiency of the application.

### Summary of Interface Check

In order to at least partially solve the deficiencies in the prior art, according to an implementation of the disclosure, a method for checking an interface of an application is provided. Referring to FIG. 2, a summary is described according to an implementation of the disclosure, and FIG. 2 shows a block diagram 200 of checking an interface of an application according to some implementations of the disclosure. As shown in FIG. 2, a method for checking an interface of an application is provided. An interface description 210 of the interface of the application may be obtained. Here, the interface description 210 may define at least one visual element to be presented in the interface of the application.

According to some implementations of the disclosure, the interface description may be defined in a plurality of formats, for example, one or more attributes of respective visual elements may be defined in a text format, for example, including but not limited to an identifier, a name, a position, a size, a shape, and the like. For another example, various visual elements may be defined in a multi-layer image manner, each image may be located in a separate image layer, the one or more attributes of the visual element may be stored in a text record, and an association relationship is established between the image layer and the text record. For another example, the interface description may be stored in other formats, for example, various visual elements may be stored in a format supported by an interface design tool, and the like. At this point, the interface description 210 may be derived directly from the interface design tool.

At least one visual element (e.g., a visual element 120, etc.) in the interface of the application may be determined based on the interface description 210 of the interface of the application. A constraint 230 associated with the interface of the application may be obtained. Specifically, the constraint 230 may be input by a developer (also referred to as a user). Alternatively and/or additionally, the constraint 230 may be imported from a predefined configuration file, may be manually updated after being imported, and the like. The at least one visual element may be checked based on the constraint 230, and a check result 240 may be provided. Specifically, in response to determining that a visual element of the at least one visual element does not meet the constraint, alert information 250 may be provided in the check result 240 to indicate that the visual element does not pass an interface check. According to the implementation of the disclosure, whether respective visual elements in the interface of the application meet the constraint may be automatically checked. In this way, the interface check may be performed in a more efficient manner, thereby improving the development efficiency of the application.

### Detailed Process of Interface Check

Having described a summary according to some implementations of the disclosure, more details regarding a method for checking an interface of an application will be described below. FIG. 3 shows a block diagram 300 of one interface of a check tool according to some implementations of the disclosure. As shown in FIG. 3, a check tool 310 may be provided, which may read relevant information of various visual element defined in the interface description 210, thereby performing a process of the interface check. The check tool 310 may include a plurality of paging tabs, e.g., a paging tab 312 may correspond to a home interface, and a user may click on a control 316 to specify an interface to be inspected. In response to detecting an access request of the user for the control 316, a dialog box may be presented for specifying an access address of the interface description 210. The user may specify an address of the interface description 210 in the dialog box, at which point the check tool 310 will read the relevant information of respective visual elements in the interface description 210.

According to some implementations of the disclosure, the interface description 210 may be stored in a variety of formats. For example, the interface description may store at least one visual element in a tree structure. In this case, the related information of the visual element may be stored in a node in the tree structure, and the visual element of the at least one visual element may be determined based on an association relationship between a root node of the tree structure and a plurality of nodes in the tree structure. Specifically, the visual element may have a hierarchical level, and respective nodes may be traversed from the root node of the tree structure, for example, in a depth-first fashion, to obtain information associated with each visual element. With some implementations of the disclosure, respective visual elements in the interface of the application may be traversed in a more efficient manner.

It should be understood that, in a process of setting the interface by the user, multiple alternatives may be provided. For example, in different alternative technical solutions, different texts may be set for buttons in the interface to select an alternative technical solution that more contributes to an end-user operation of the application. In this case, the button in an alternative technical solution may be set to be “visible”, and the button in other alternative technical solution(s) may be set to be “invisible”. At this time, in a process of determining the at least one visual element in the interface of the application, a plurality of visual elements in the interface may be obtained based on the interface description, where the plurality of visual elements include a visible visual element and/or an invisible visual element. Then, the at least one visual element may be selected from the plurality of visual elements based on a display attribute (e.g., visible, or invisible) of the plurality of visual elements. With some implementations of the disclosure, numerous invisible elements in the interface may be ignored, and the workload of the check project is reduced.

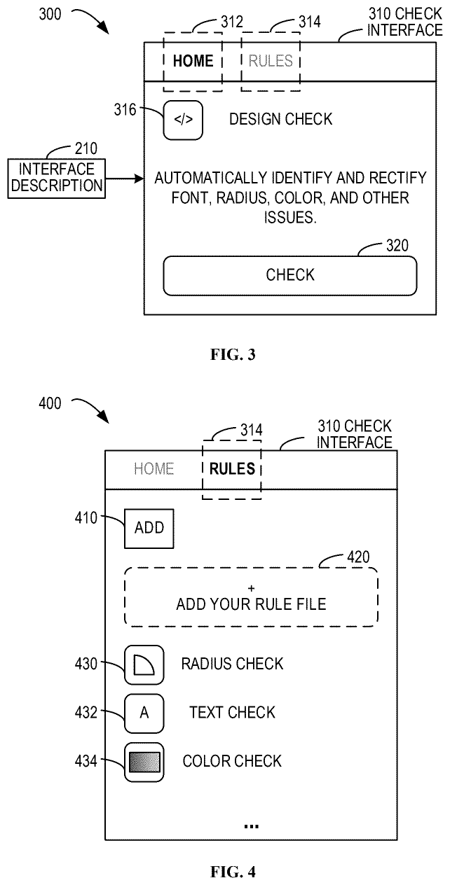

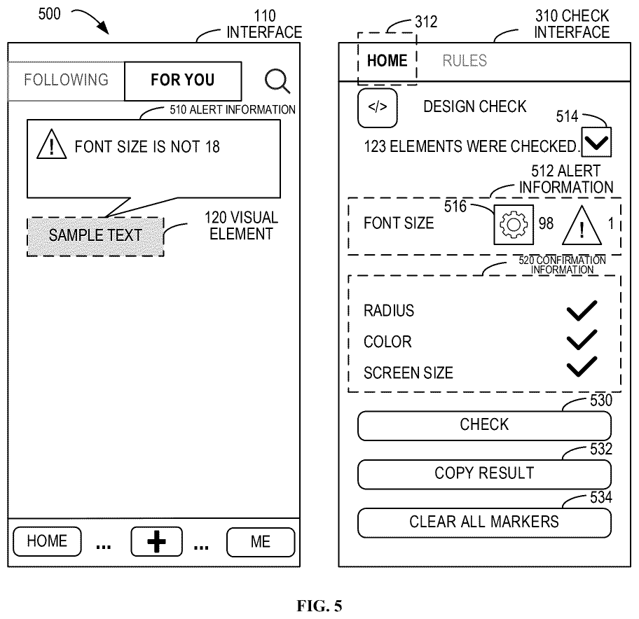

According to some implementations of the disclosure, in a process of obtaining the constraint associated with the interface of the application, a specifying control for specifying the constraint may be provided; and in response to receiving an access request for the specifying control, the constraint is determined based on the access request. With some implementations of the disclosure, an auxiliary tool for setting the constraint may be provided, thereby facilitating the users to set a corresponding constraint according to their own requirements. Referring to FIG. 3, more details are described, the check tool 310 may provide a paging tab 314 and the user may click the paging tab 314 to switch to an interface for specifying the constraint. In response to detecting an access request for the paging tag 314, an interface as shown in FIG. 4 may be presented FIG. 4 shows a block diagram 400 of another interface of the check tool according to some implementations of the disclosure.

According to some implementations of the disclosure, the constraint may include at least any of: an appearance, a text, a color and a position of a visual element of the at least one visual element, and a positional relationship between the visual element and a further visual element of the at least one visual element. Here, the appearance may include, for example, a shape of the visual element, a width of a border, a corner radius, a pattern, a shading, and the like. The text may include, for example, a font, a font size, an italic, bolding, underlining, and the like of the text presented in the visual element. The position may include, for example, a coordinate of the visual element in the interface of the application, a distance between four borders of the interface, and/or the like. The positional relationship may include, for example, a horizontal distance and a vertical distance between the visual element and other visual elements, and the like. With some implementations of the disclosure, the constraint that respective visual elements should follow may be specified from multiple aspects, thereby enabling the development of applications in a more accurate manner.

According to some implementations of the disclosure, in a process of determining the constraint based on the access request, a setting control for setting a parameter of the constraint may be provided; and in response to receiving an access request for the setting control, the constraint is set based on the access request. As shown in FIG. 4, in a constraint setting interface, an adding control 410 may be presented. The user may click the adding control 410 to import a predefined constraint into the check tool. Alternatively and/or additionally, a constraint file may be selected and the constraint file is dragged into a region 420 in order to add a constraint into the check tool 310.

According to some implementations of the disclosure, different types of constraints may be added one by one. For example, the user may click on a control 430 to add and/or edit a constraint for checking the appearance (e.g., a radius of an outline) of the visual element. It should be understood that the radius herein is only an example of appearance. Alternatively and/or additionally, other constraints related to a line width, a pattern, shading, etc. of the outline of the visual element may be added. As another example, the user may click on a control 432 to add and/or edit a constraint for checking the text in the visual element. The constraint may specify information such as the font, font size, underlining, italic, bolding, etc. of the text. As another example, the user may click on the control 434 to add and/or edit a constraint for checking the color of the visual element. The constraint may specify information such as a color, saturation, contrast, etc. of the visual element.

It should be understood that although only an example of constraining all visual elements suitable for use in the interface is schematically illustrated above, alternatively and/or additionally, the constraint may be set for part of the visual elements in the interface. For example, a type of visual element may first be determined and the constraint is set based on the type. Assuming that the interface includes a visual element of a button type and a visual element of a menu type, respective constraints may be set for two types of visual elements, respectively. Taking the font size as an example, the constraint for the visual element of the button type may specify that the font size of the text presented in the button is 18; and the constraint for the visual element of the menu type may specify that the font size of the text presented in the menu is 16, and the like.

Returning to FIG. 3, after the constraint has been specified in the paging tab 314, the user may click on the control 320 to perform a checking process. According to some implementations of the disclosure, in a process of checking the at least one visual element based on the constraint, the visual element of the at least one visual element may be determined based on an association relationship between a root node of the tree structure and a plurality of nodes in the tree structure; and at least one attribute of the visual element is checked based on the constraint. Specifically, respective visual elements in the tree structure may be traversed, and it is determined whether respective visual elements meet a specified constraint. Taking the font size as an example, the font size in the constraint may be compared with a font size of the text in respective visual elements one by one in order to determine the visual element that goes against the constraint. Assuming that the font size specified by the constraint is 18, alert information may be provided when it is found that the font size of a certain visual element is 20. Subsequent constraint(s) may be handled in a similar manner in the case of multiple constraints.

Assuming that the color constraint specifies that the color of the text is black, the black in the constraint may be compared with the color of the text in respective visual elements one by one in order to determine the visual element that goes against the constraint. Assuming that the color of the text in a certain visual element is found to be blue, alert information may be provided. With some implementations of the disclosure, for each visual element in the interface, it may be determined whether each visual element meets one or more constraints as specified. In this way, all of the visual elements in the application may be automatically checked, so that the interface check efficiency is improved, and thus the application development efficiency is improved.

According to some implementations of the disclosure, the alert information may be provided in multiple ways in the case that a visual element that does not meet the constraint is found. For example, the alert information may be provided in the check tool, and alternatively and/or additionally, the alert information may be presented at a position in the interface of the application associated with the visual element. Further details are described with reference to FIG. 5, which shows a block diagram of an interactive interface 500 of the check tool according to some implementations of the disclosure. As shown in FIG. 5, the interactive interface 500 of the check tool may include two parts, the left side showing the interface 110 of the application being checked, and the right side showing the check interface 310.

According to some implementations of the disclosure, the alert information may include at least any of: a reason why the visual element fails the interface check; or a position of the visual element in the interface of the application. Specifically, assuming that the font size of the visual element 120 in a discovery interface 110 does not meet the constraint, the alert information 512 may be presented in the check interface 310 to indicate that the font size does meet the constraint. Alternatively and/or additionally, alert information 510 may be presented at a position associated with visual element 120 in the interface 110 to indicate that the font size of the visual element 120 does not meet the size of 18 specified in the constraint. Alternatively and/or additionally, the wrong visual element 120 may be presented with different visual properties, e.g., may indicate that the visual element does not meet the constraint in a yellow, or other striking color. With some implementations of the disclosure, the user may be provided with detailed information about whether respective visual elements meet the constraint, thereby facilitating the user to update respective visual elements in the interface.

Further, a check result in the check interface 310 may include more information. For example, the number of visual elements that have been checked may be presented, and a control 514 may be pressed to present the details related to the respective visual elements. Alternatively and/or additionally, an adjusting control for adjusting the visual element may be provided. In response to receiving an access request for the alert information, an adjusting control for adjusting the visual element is provided; and in response to receiving an access request for the adjusting control, the visual element is updated based on the access request. For example, the user may press a control 516 to adjust one or more attributes of the visual element, e.g., a font, a font size, etc. Alternatively and/or additionally, the user may interact with the alert information 510 and/or the visual element 120 in order to update the visual element. With some implementations of the disclosure, the user may adjust the visual element directly in the check tool, and the user does not have to switch back and forth between an interface definition tool and the interface check tool. In this way, the complexity of the application development may be reduced, and the application development efficiency may be improved.

According to some implementations of the disclosure, the attribute of the visual element that goes against the constraint may be automatically corrected. For example, it may be queried to the user in the interface 110 (or the check interface 310) about whether an automatic correction is required. In response to receiving the user confirmation that the automatic correction is required, the corrected visual element may be provided, for example, the font size of the visual element may be set to be 18. Alternatively and/or additionally, it may be queried to the user about whether the corrected interface needs to be saved. In response to receiving that the user confirmation that it needs to be saved, an interface description representing the corrected interface may be stored. In this way, the interface of the application may be updated directly in the check tool.

According to some implementations of the disclosure, in response to determining that the at least one visual element meet the constraint, confirmation information is provided to indicate that the at least one visual element passes the interface check. As shown in the check interface 310, confirmation information 520 may be provided, which may indicate that a radius, a color, a screen size of respective visual elements in the application meet the constraint. With some implementations of the disclosure, the check result may provide richer information about various visual elements in the interface. In this way, the user may be supported to develop an application in a more efficient manner.

According to some implementations of the disclosure, the check interface 310 may provide more controls: a control 530 may perform the check process again, and a control 534 may clearly check respective alert marks in the result. Alternatively and/or additionally, according to some implementations of the disclosure, the check interface 310 may further provide a storing control for storing the check result of the interface check; and in response to receiving an access request for the storing control, the check result is stored to a target position specified by the access request. Specifically, the user may press a control 532 to store the check result to the specified target position. The check result may be stored in a variety of formats, for example, related check results for all visual elements in the interface may be recorded in a text format. For another example, only the check result of the visual element that goes against the constraint may be recorded, etc. Alternatively and / or additionally, the check result may be recorded in a text and image manner, and specifically, image information of the original visual element and/or the corrected visual element may be recorded, and the like. With some implementations of the disclosure, it facilitates the user to review an update history of the interface of the application, thereby recording the development process of the application.

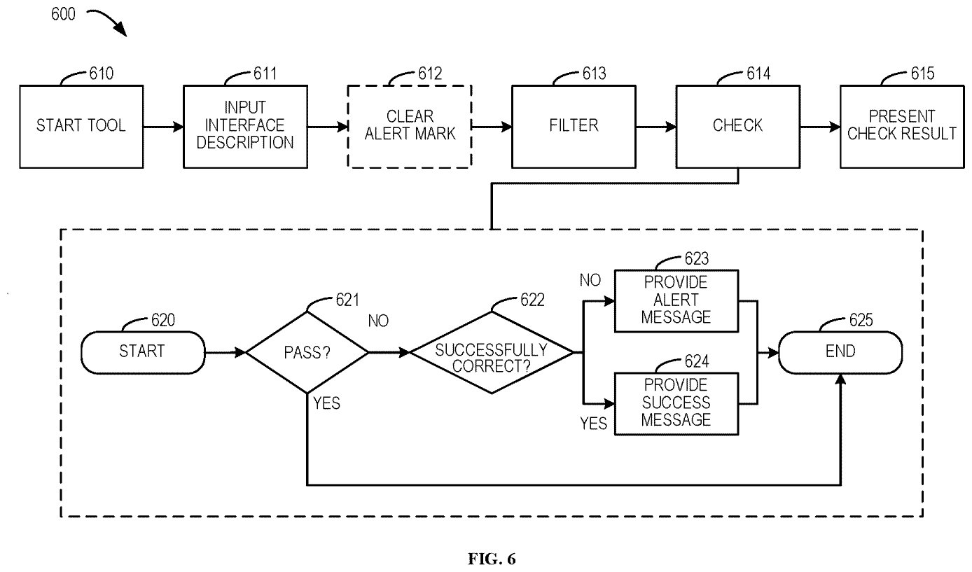

Having described various steps in accordance with some implementations of the disclosure, a complete flow of the interface check process is described below with reference to FIG. 6. FIG. 6 shows a block diagram 600 of a process of performing an interface check using an interface check tool according to some implementations of the disclosure. As shown in FIG. 6, at block 610, the check tool may be started. At block 611, the interface description of the interface to be checked may be input. At block 612, the alert flag may be cleared if an alert occurs during the last check. At block 613, one or more visual elements that are visible may be filtered out of the interface description. At block 614, the one or more filtered visual elements may be checked.

Specifically, steps at block 614 may be refined. At block 620, an operation begins. At block 621, if the visual element passes the check, flow may proceed to block 625 and end. If the visual element fails the check, the flow proceeds to block 622 to automatically correct errors in the visual element. If the correction is successful, the flow proceeds to block 624 in order to provide a message that the correction is successful. If the correction fails, the flow proceeds to block 623 to provide an alert message to indicate that the correction fails. Each of the visual elements in the interface may be processed one by one in a similar manner, and the check result may be presented at block 615.

It should be understood that while an example of one interface of an check application is described above with only a single interface taken as an example, the application may include a plurality of interfaces. Each interface may be processed in the manner described above to determine whether respective interfaces in the application meet a predetermined constraint. According to the implementation of the disclosure, it may be automatically checked whether the respective visual elements in the interface of the application meet the constraint. In this way, the interface check may be performed in a more efficient manner, thereby improving the development efficiency of the application.

### Example Process

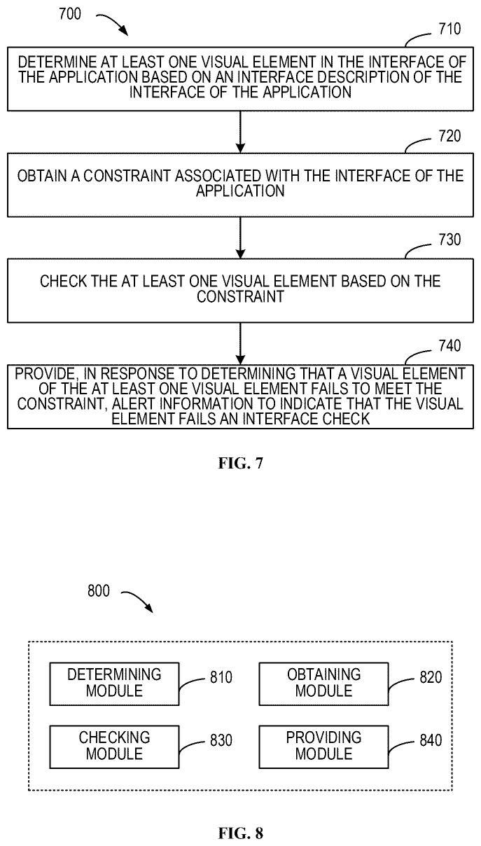

FIG. 7 shows a flowchart of a method 700 for checking an interface of an application according to some implementations of the disclosure. At block 710, at least one visual element in the interface of the application is determined based on an interface description of the interface of the application. At block 720, a constraint associated with the interface of the application is obtained. At block 730, the at least one visual element is checked based on the constraint. At block 740, in response to determining that a visual element of the at least one visual element fails to meet the constraint, alert information is provided to indicate that the visual element fails an interface check.

According to some implementations of the disclosure, obtaining the constraint associated with the interface of the application includes: providing a specifying control for specifying the constraint; and determining the constraint based on an access request for the specifying control in response to receiving the access request.

According to some implementations of the disclosure, determining the constraint based on the access request includes: providing a setting control for setting a parameter of the constraint; and setting the constraint based on an access request for the setting control in response to receiving the access request.

According to some implementations of the disclosure, the interface description stores the at least one visual element in a tree structure, and checking the at least one visual element based on the constraint includes: determining the visual element of the at least one visual element based on an association relationship between a root node of the tree structure and a plurality of nodes in the tree structure; and checking at least one attribute of the visual element based on the constraint.

According to some implementations of the disclosure, providing the alert information includes presenting the alert information at a position associated with the visual element in the interface of the application.

According to some implementations of the disclosure, the alert information includes at least any of: a reason why the visual element fails the interface check; or a position of the visual element in the interface of the application.

According to some implementations of the disclosure, the method further includes: providing an adjusting control for adjusting the visual element in response to receiving an access request for the alert information; and updating the visual element based on an access request for the adjusting control in response to receiving the access request.

According to some implementations of the disclosure, the constraint associated with the interface of the application includes at least any of: an appearance, a text, a color, and a position of the visual element of the at least one visual element, and a positional relationship between the visual element and a further visual element of the at least one visual element.

According to some implementations of the disclosure, determining the at least one visual element in the interface of the application includes: obtaining a plurality of visual elements in the interface based on the interface description; and selecting the at least one visual element from the plurality of visual elements based on a display attribute of the plurality of visual elements.

According to some implementations of the disclosure, the method further includes: providing confirmation information to indicate that the at least one visual element passes the interface check in response to determining that the at least one visual element meets the constraint.

According to some implementations of the disclosure, the method further includes: providing a storing control for storing a check result of the interface check; and storing the check result to a target position specified by an access request for the storing control in response to receiving the access request.

### Example Apparatus and Device

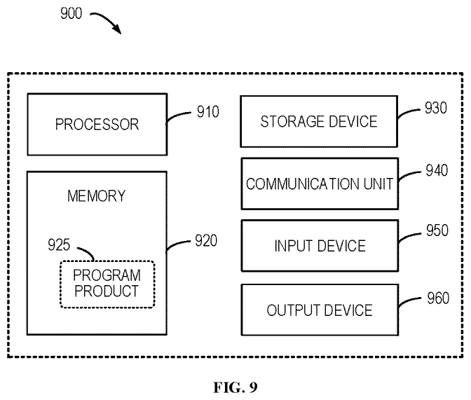

FIG. 8 shows a block diagram of an apparatus 800 for checking an interface of an application according to some implementations of the disclosure. The apparatus includes: a determining module 810 configured to determine at least one visual element in the interface of the application based on an interface description of the interface of the application; an obtaining module 820 configured to obtain a constraint associated with the interface of the application; a checking module 830 configured to check the at least one visual element based on the constraint; and a providing module 840 configured to provide, in response to determining that a visual element of the at least one visual element fails to meet the constraint, alert information to indicate that the visual element fails an interface check.

According to some implementations of the disclosure, the obtaining module is further configured to include: providing a specifying control for specifying the constraint; and determining a constraint based on an access request for the specifying control in response to receiving the access request.

According to some implementations of the disclosure, the obtaining module is further configured to: provide a setting control for setting a parameter of the constraint; and set the constraint based on an access request for the setting control in response to receiving the access request.

According to some implementations of the disclosure, the interface description stores at least one visual element in a tree structure, and the checking module is further configured to: determine the visual element of the at least one visual element based on an association relationship between a root node of the tree structure and a plurality of nodes in the tree structure; and check at least one attribute of the visual element based on the constraint.

According to some implementations of the disclosure, the providing module is further configured to present the alert information at a position associated with the visual element in the interface of the application.

According to some implementations of the disclosure, the alert information includes at least any of: a reason why the visual element fails the interface check; or a position of the visual element in the interface of the application.

According to some implementations of the disclosure, the apparatus further includes a processing module configured to: provide an adjusting control for adjusting the visual element in response to receiving an access request for the alert information; and update the visual element based on an access request for the adjusting control in response to receiving the access request.

According to some implementations of the disclosure, the constraint associated with the interface of the application includes at least any of: an appearance, a text, a color, and a position of the visual element of the at least one visual element, and a positional relationship between the visual element and a further visual element of the at least one visual element.

According to some implementations of the disclosure, the determining module is further configured to: obtain a plurality of visual elements in the interface based on the interface description; and select the at least one visual element from the plurality of visual elements based on a display attribute of the plurality of visual elements.

According to some implementations of the disclosure, the providing module is further configured to: provide confirmation information to indicate that the at least one visual element passes the interface check in response to determining that the at least one visual element meets the constraint.

According to some implementations of the disclosure, the providing module is configured to: provide a storing control for storing a check result of the interface check; and store the check result to a target position specified by an access request for a storing control in response to receiving the access request.

FIG. 9 shows a block diagram of a device 900 capable of implementing various implementations of the disclosure. It should be understood that a computing device 900 shown in FIG. 9 is merely illustrative and should not constitute any limitation on the functionality and scope of the implementations described herein. The computing device 900 shown in FIG. 9 may be configured to implement the method described above.

As shown in FIG. 9, the computing device 900 is in a form of a general-purpose computing device. Components of the computing device 900 may include, but are not limited to, one or more processors or processing units 910, a memory 920, a storage device 930, one or more communication units 940, one or more input devices 950, and one or more output devices 960. The processing unit 910 may be an actual or virtual processor and capable of performing various processes according to programs stored in the memory 920. In a multiprocessor system, the plurality of processing units execute computer-executable instructions in parallel to improve the parallel processing capability of the computing device 900.

The computing device 900 generally includes a plurality of computer storage media. Such media may be any available media accessible by the computing device 900, including, but not limited to, volatile and non-volatile media, removable and non-removable media. The memory 920 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 930 may be a removable or non-removable medium and may include a machine-readable medium, such as a flash drive, a magnetic disk, or any other medium, which may be capable of storing information and/or data (e.g., training data for training) and may be accessed within the computing device 900.

The computing device 900 may further include additional removable/non-removable, volatile/non-volatile storage media/medium. Although not shown in FIG. 9, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 920 may include a computer program product 925 having one or more program modules configured to perform various methods or actions of various implementations of the disclosure.

The communication unit 940 implements communication with other computing devices through a communications medium. Additionally, the functionality of components of the computing device 900 may be implemented in a single computing cluster or multiple computing machines capable of communicating over a communication connection. Thus, the computing device 900 may operate in a networked environment using logical connection(s) with one or more other servers, a network personal computer (PC), or another network node.

The input device 950 may be one or more input devices such as a mouse, a keyboard, a trackball, or the like. The output device 960 may be one or more output devices, such as a display, a speaker, a printer, or the like. The computing device 900 may also communicate with one or more external devices (not shown) through the communication unit 940 as needed, the external device, such as a storage device, a display device, or the like, communicates with one or more devices that enable a user to interact with the computing device 900, or communicates with any device (e.g., a network card, a modem, etc.) that enables the computing device 900 to communicate with one or more other computing devices. Such communication may be performed via an input/output (I/O) interface (not shown).

According to an implementation of the disclosure, there is provided a computer-readable storage medium having computer-executable instructions stored thereon, and the computer-executable instructions are executed by a processor to implement the method described above. According to an implementation of the disclosure, a computer program product is further provided, the computer program product being tangibly stored on a non-transitory computer-readable medium and including computer-executable instructions, the computer-executable instructions being executed by a processor to implement the method described above. According to an implementation of the disclosure, there is provided a computer program product having stored thereon a computer program, which, when executed by a processor, implements the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combination(s) of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of the computer or other programmable data processing apparatus, produce means to implement the functions/acts specified in one or more blocks in the flowchart(s) and/or block diagram(s). These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto the computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowcharts and block diagrams in the figures show architecture, functionality, and operation that may be possibly implemented by system(s), method(s), and computer program product(s) according to various implementations of the disclosure. In this regard, each block in the flowchart or block diagram may represent a module, program segment, or part of an instruction that includes one or more executable instructions for implementing the specified logical function. In some alternative implementations, the functions noted in the block(s) may also occur in a different order than noted in the figures. For example, two consecutive blocks may actually be performed substantially in parallel, which may sometimes be performed in the reverse order, depending on the functionality involved. It is also noted that each block in the block diagram and/or flowchart, as well as combination(s) of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for checking an interface of an application, comprising:
determining at least one visual element in the interface of the application based on an interface description of the interface of the application;
obtaining a constraint associated with the interface of the application;
checking the at least one visual element based on the constraint; and
providing, in response to determining that a visual element of the at least one visual element fails to meet the constraint, alert information to indicate that the visual element fails an interface check.

2. The method of claim 1, wherein obtaining the constraint associated with the interface of the application comprises:
providing a specifying control for specifying the constraint; and
determining the constraint based on an access request for the specifying control in response to receiving the access request.

3. The method of claim 2, wherein determining the constraint based on the access request comprises:
providing a setting control for setting a parameter of the constraint; and
setting the constraint based on an access request for the setting control in response to receiving the access request.

4. The method of claim 1, wherein the interface description stores the at least one visual element in a tree structure, and checking the at least one visual element based on the constraint comprises:
determining the visual element of the at least one visual element based on an association relationship between a root node of the tree structure and a plurality of nodes in the tree structure; and
checking at least one attribute of the visual element based on the constraint.

5. The method of claim 1, wherein providing the alert information comprises: presenting the alert information at a position associated with the visual element in the interface of the application.

6. The method of claim 1, wherein the alert information comprises at least any of:
a reason why the visual element fails the interface check; or
a position of the visual element in the interface of the application.

7. The method of claim 1, further comprising:
providing an adjusting control for adjusting the visual element in response to receiving an access request for the alert information; and
updating the visual element based on an access request for the adjusting control in response to receiving the access request.

8. The method of claim 1, wherein the constraint associated with the interface of the application comprises at least any of: an appearance, a text, a color, and a position of the visual element of the at least one visual element, and a positional relationship between the visual element and a further visual element of the at least one visual element.

9. The method of claim 1, wherein determining the at least one visual element in the interface of the application comprises:
obtaining a plurality of visual elements in the interface based on the interface description; and
selecting the at least one visual element from the plurality of visual elements based on a display attribute of the plurality of visual elements.

10. The method of claim 1, further comprising:
providing confirmation information to indicate that the at least one visual element passes the interface check in response to determining that the at least one visual element meets the constraint.

11. The method of claim 1, further comprising:
providing a storing control for storing a check result of the interface check; and
storing the check result to a target position specified by an access request for the storing control in response to receiving the access request.

12. An electronic device, comprising:
at least one processor; and
at least one memory coupled to the at least one processor and storing instructions for execution by the at least one processor, the instructions, when executed by the at least one processor, causing the electronic device to perform acts comprising:
determining at least one visual element in the interface of the application based on an interface description of the interface of the application;
obtaining a constraint associated with the interface of the application;
checking the at least one visual element based on the constraint; and
providing, in response to determining that a visual element of the at least one visual element fails to meet the constraint, alert information to indicate that the visual element fails an interface check.

13. The electronic device of claim 12, wherein obtaining the constraint associated with the interface of the application comprises:
providing a specifying control for specifying the constraint; and
determining the constraint based on an access request for the specifying control in response to receiving the access request.

14. The electronic device of claim 12, wherein the interface description stores the at least one visual element in a tree structure, and checking the at least one visual element based on the constraint comprises:
determining the visual element of the at least one visual element based on an association relationship between a root node of the tree structure and a plurality of nodes in the tree structure; and
checking at least one attribute of the visual element based on the constraint.

15. The electronic device of claim 12, wherein providing the alert information comprises: presenting the alert information at a position associated with the visual element in the interface of the application.

16. The electronic device of claim 12, wherein the alert information comprises at least any of:
a reason why the visual element fails the interface check; or
a position of the visual element in the interface of the application.

17. The electronic device of claim 12, wherein the acts further comprising:
providing an adjusting control for adjusting the visual element in response to receiving an access request for the alert information; and
updating the visual element based on an access request for the adjusting control in response to receiving the access request.

18. The electronic device of claim 12, wherein the constraint associated with the interface of the application comprises at least any of: an appearance, a text, a color, and a position of the visual element of the at least one visual element, and a positional relationship between the visual element and a further visual element of the at least one visual element.

19. The electronic device of claim 12, wherein determining the at least one visual element in the interface of the application comprises:
obtaining a plurality of visual elements in the interface based on the interface description; and
selecting the at least one visual element from the plurality of visual elements based on a display attribute of the plurality of visual elements.

20. A non-transitory computer-readable storage medium having stored thereon computer instructions that, when executed by a processor, cause the processor to perform acts comprising:
determining at least one visual element in the interface of the application based on an interface description of the interface of the application;
obtaining a constraint associated with the interface of the application;
checking the at least one visual element based on the constraint; and
providing, in response to determining that a visual element of the at least one visual element fails to meet the constraint, alert information to indicate that the visual element fails an interface check.
